(19) United States
(12) Patent Application Publication
(10) Pub. No.: US 2012/0133199 A1
(43) Pub. Date: May 31, 2012

(54) BICYCLE HUB ASSEMBLY WITH TWO TRANSMISSION DIRECTIONS

(75) Inventor: PI-YUN CHIANG, TAICHUNG HSIEN (TW)

(73) Assignee: JOY INDUSTRIAL CO., LTD., TAICHUNG HSIEN (TW)

(21) Appl. No.: 12/956,270

(22) Filed: Nov. 30, 2010

(51) Int. Cl. B60B 27/00

(52) U.S. Cl. 301/110.5

(57) ABSTRACT

A bicycle hub assembly includes a hub and a tubular portion extends from one end of the hub. A sprocket is connected to the tubular portion. A ratchet unit is located between the hub and the transmission unit so that the hub and the transmission unit are operatively connected to each other indirectly and in one way by the ratchet unit. A control unit has first positioning portions on the hub and second positioning portions integrally formed with the tubular portion. The first positioning portions and the second positioning portions are connected to each other by bolts, and the first positioning portions and the second positioning portions are separated from each other when the bolts are removed. The hub assembly can be switched between direct and two-way transmission into indirect and one-way transmission by arrangement of the bolts.

### FIELD OF THE INVENTION

The present invention relates to a bicycle hub assembly, and more particularly, to a bicycle hub assembly having direct two-way transmission and indirect one-way transmission.

### BACKGROUND OF THE INVENTION

A conventional bicycle wheel is rotatable about the center thereof and the hub is located at the center and spokes are connected between the rim and the hub so as to keep the rim to be circular.

The transmission of the hub generally includes a sprocket and a chain which is connected between the sprocket on the hub and a chainwheel at the bottom bracket so that when the chainwheel is rotated, the sprocket is rotated and drives the wheel move forward or backward.

The way of transmission generally includes direct transmission and indirect transmission, wherein the direct transmission means that the sprocket and the hub is directly connected to each other, so that when the hub rotates, the sprocket rotates. The indirect transmission includes a ratchet unit or the like between the sprocket and the hub, the force is transferred between the sprocket and the hub by the ratchet unit.

The bicycle wheel can be driven in one way or in two ways, wherein the one-way driving means that the hub only works in one direction and the hub is not rotated in the opposite direction. Usually, the direction that the hub works is the direction that the bicycle moves forward. The hub of this type of operation is cooperated with the ratchet unit. The two-way driven of the wheel means that the hub drives the wheel clockwise and counter clockwise as the hub rotates clockwise and counter clockwise. The hub of this type of operation is cooperated without the ratchet unit.

The hub with the ratchet unit is designed to work in one direction and is cataloged as the indirect and one-way transmission hub. The hub without the ratchet unit is the two-way transmission hub which has the sprocket directly connected to the hub so as to directly drive the wheel.

The conventional indirect and one-way transmission hub is disclosed in Taiwan Utility Patent Application Number 097216576 and includes an axle, a hub mounted to the axle and having two flanges, a ratchet unit mounted to the axle and located on a side of the hub, the ratchet unit including at least one chainwheel on one side of the ratchet unit, a polygonal block located on the other side of the ratchet unit, a clutch unit mounted to the axle and including multiple rollers contacting the outside of the polygonal block, each roller located corresponding to one side of the block, a collar mounted to the block and having multiple notches in which the rollers are received, a spring ring mounted to the collar and retaining the rollers, a transmission ring located around the clutch unit and connected to the flanges. When the rollers are located at the center of the outside of the block, the rollers are separated from the transmission ring. When the rollers are located away from the center of the outside of the block, the rollers are in contact with the transmission ring.

The conventional direct and two-way transmission hub is disclosed in Taiwan Utility Patent Application Number 098219605 and includes an axle extending through a hub located at the center of a wheel, the hub having flanges and multiple first engaging portions are located on the outside of the flange, a sprocket is connected to the outside of the flange and having multiple gears, multiple second engaging portions located on the sprocket and located corresponding to and engaged with the first engaging portions, and a positioning unit having a positioning ring threadedly connected to the hub and positioning the sprocket.

However, the components and the arrangement of the components between the indirect and one-way transmission hub and the direct and two-way transmission hub are quite different so that one bicycle can only use one of them and cannot be equipped with both. There will be impossible to switch the two different ways of transmission on one bicycle. If the bicycle needs to change the transmission system from the indirect and one-way transmission hub into the direct and two-way transmission hub, the time required will be very long and the work is complicated. For the bicycle manufacturers, the different components need different molds to fabricate and the management of the material, parts and processes is significant.

The primary object of the present invention is to provide a bicycle hub assembly having a control unit for switching the transmission way between direct and two-way transmission into indirect and one-way transmission.

Another object of the present invention is to provide a bicycle hub assembly with two transmission ways and the components are commonly used without extra expense on molds and equipment.

Yet another object of the present invention is to provide a bicycle hub assembly wherein the switch of the transmission ways is easy without dispatching and assembling processes.

### SUMMARY OF THE INVENTION

The present invention relates to a bicycle hub assembly and comprises a hub with an axle extending centrally therethrough and the hub is rotatable relative to the axle. A transmission unit has a tubular portion extending from one end of the hub and at least one sprocket is connected to the tubular portion. A ratchet unit is located between the hub and the transmission unit, the hub and the transmission unit are operatively connected to each other indirectly and transfer force in one way by the ratchet unit. A control unit has at least one first positioning portion on the hub and at least one second positioning portion integrally formed with the tubular portion. The at least one first positioning portion and the at least one second positioning portion are connected to each other by a bolt so that the hub assembly is a direct two-way transmission hub assembly. The at least one first positioning portion and the at least one second positioning portion are separated from each other when the bolt is removed so that the hub assembly is a direct two-way transmission hub assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle hub assembly of the present invention;

FIG. 2 is an exploded view to show the bicycle hub assembly of the present invention;

FIG. 3 is a cross sectional view to show the bicycle hub assembly of the present invention, wherein the bolts are used;

FIG. 4 is a cross sectional view to show the bicycle hub assembly of the present invention, wherein the bolts are removed;

FIG. 5 shows another embodiment of the flange of the transmission unit;

FIG. 6 shows another embodiment of the bolts used to the bicycle hub assembly of the present invention;

FIG. 7 is an exploded view to show the bicycle hub assembly of the present invention as disclosed in FIG. 6;

FIG. 8 is a cross sectional view to show the bicycle hub assembly of the present invention in FIG. 7, wherein the bolts are used;

FIG. 9 is a cross sectional view to show the bicycle hub assembly of the present invention in FIG. 7, wherein the bolts are removed;

FIG. 10 shows that there are multiple gears are mounted to the mounting portion of the transmission unit;

FIG. 11 is a cross sectional view to show the bicycle hub assembly of the present invention in FIG. 10, wherein the bolts are used;

FIG. 12 is a perspective view to show yet another embodiment of the bicycle hub assembly of the present invention;

FIG. 13 is an exploded view to show the bicycle hub assembly of the present invention in FIG. 12, and

FIG. 14 is a cross sectional view to show the bicycle hub assembly of the present invention in FIG. 13.

### DETAILED DESCRIPTION OF THE PREFERRED EMBODIMENT

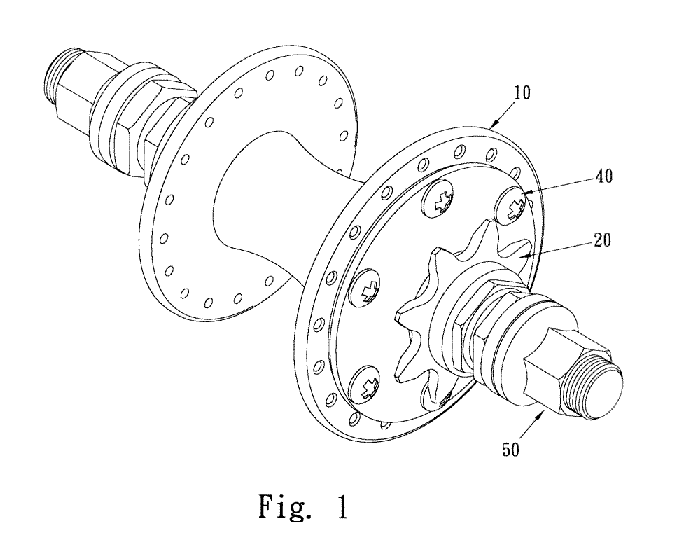

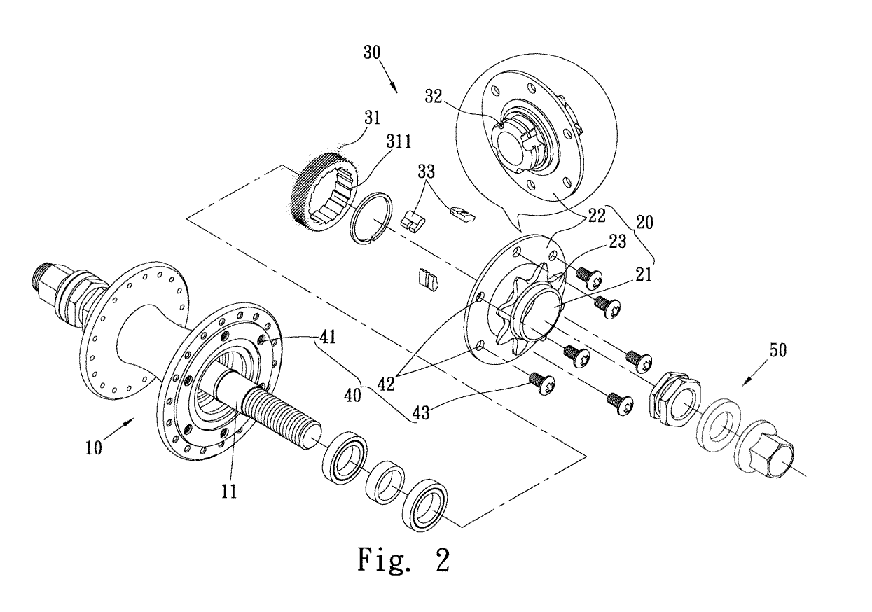

Referring to FIGS. 1 to 4, the bicycle hub assembly of the present invention comprises a hub 10, a transmission unit 20 connected to the hub 10, a ratchet unit 30, a control unit 40 located between the hub 10 and the transmission unit 20, and a positioning unit 50 on the outside of the hub 10.

The hub 10 includes an axle 11 extending centrally therethrough and the hub 10 is rotatable relative to the axle 11.

The transmission unit 20 has a tubular portion 21 extending from one end of the hub 10 and the tubular portion 21 includes a flange 22 which is larger than the tubular portion 21. A sprocket 23 is connected to the tubular portion 21 and located on a first side of the flange 22.

The ratchet unit 30 is located between the hub 10 and the transmission unit 20. The hub 10 and the transmission unit 20 are operatively connected to each other indirectly and transfer force in one way by the ratchet unit 30. The ratchet unit 30 includes a ratchet ring 31 which is located in an end of the hub 10, and a driving shaft 32 is located on the second side of the flange 22 and opposite to the tubular portion 21. The ratchet ring 31 includes multiple ratchet teeth 311 in an inner periphery thereof. Three pawls 33 are pivotably engaged with the driving shaft 32 and removably engaged with the ratchet teeth 311.

The control unit 40 has at least one first positioning portion 41 on the hub 10 and at least one second positioning portion 42 is integrally formed with the tubular portion 21. In this embodiment, there are multiple first and second positioning portions 41, 42. The second positioning portions 42 are holes and the first positioning portions 41 are threaded holes which are located in an end of the hub 10 and corresponding to the second positioning portions 42. Bolts 43 are used to extend through the second positioning portions 42 and connected to the first positioning portions 41.

The positioning unit 50 is located on outside of the tubular portion 21 and threadedly mounted to the axle 11 to secure the tubular portion 21 on the axle 11.

By installing the bolts 43 or removing the bolts 43, the hub 10 and the transmission unit 20 are connected to each other or separated from each other so as to switch the transmission way from direct transmission to indirect transmission without adding any component.

When assembling, the hub 10 is rotatably mounted to the axle 11 and the ratchet ring 31 is threadedly connected to inside of the hub and the pawls 33 are connected to the driving shaft 32. The driving shaft 32 and the pawls 33 are located in the inner periphery of the ratchet ring 31 so that the pawls 33 are engaged with the ratchet teeth 311. Finally, the positioning unit 50 is mounted to the axle 11 and contacts against the outside of the tubular portion 21 to complete the assembly.

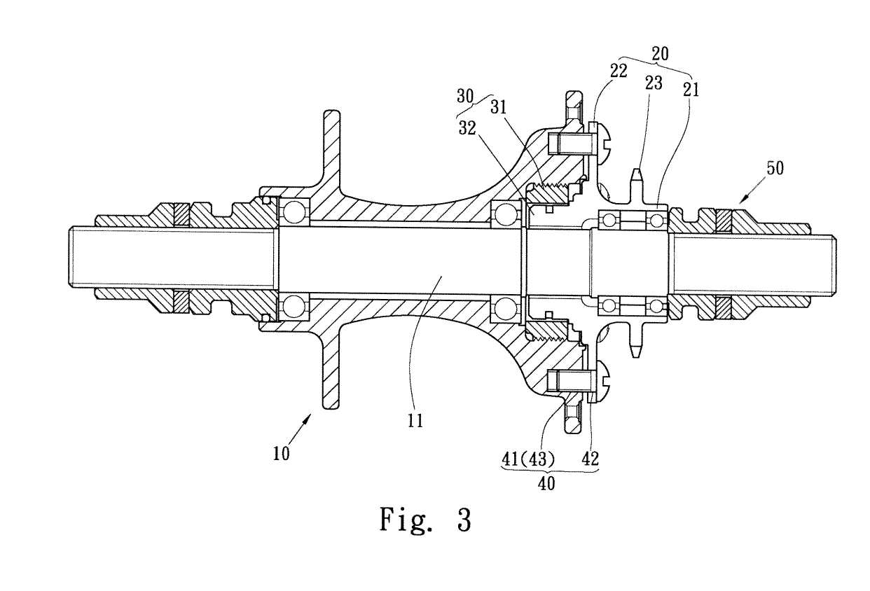

When the hub assembly is a direct and two-way transmission hub assembly, as shown in FIG. 3, the bolts 43 are connected to the first and second positioning portions 41, 42. When the chain drives the sprocket 23 clockwise, the hub 10 is rotated clockwise. On the contrary, when the chain drives the sprocket 23 counter clockwise, the hub 10 is rotated counter clockwise. Therefore, the hub assembly is a direct and two-way transmission hub assembly.

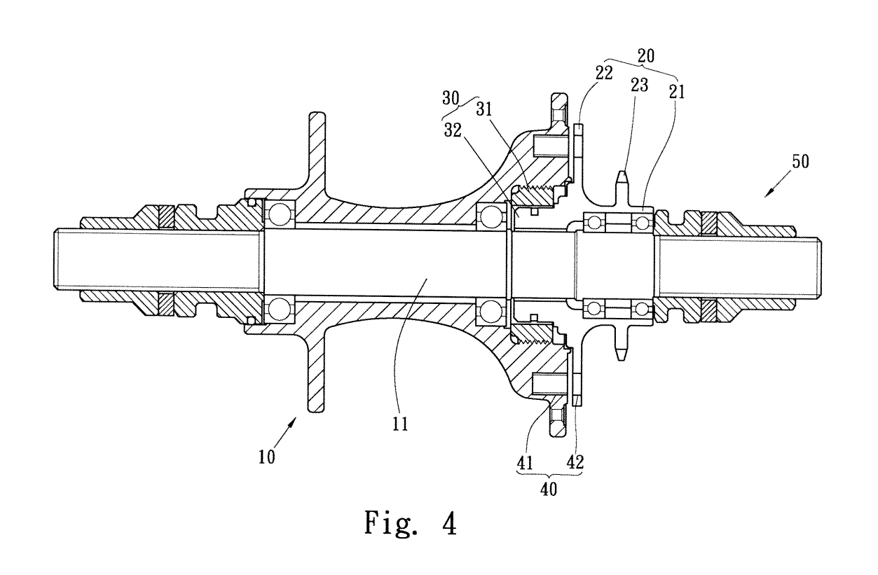

When the hub assembly is a indirect and one-way transmission hub assembly, as shown in FIG. 4, the bolts 43 are removed from the first and second positioning portions 41, 42. The hub 10 and the transmission unit 20 are separated from each other. The transmission unit 20 drives the hub 10 indirectly and by the ratchet unit 30. When the chain drives the sprocket 23 counter clockwise, the bicycle moves forward and the ratchet unit 30 rotates counter clockwise and drives the hub 10 to rotate counter clockwise. On the contrary, when the chain drives the sprocket 23 clockwise, ratchet unit 30 rotates clockwise and cannot drive the hub 10. Therefore, the hub assembly is an indirect and one-way transmission hub assembly.

By connecting the bolts 43 to the first and second positioning portions 41, 42, or removing the bolts 43 from the first and second positioning portions 41, 42, the hub 10 and the transmission unit 20 are connected to each other or separated from each other so as to switch the transmission way from direct transmission to indirect transmission without adding any component. The switch is easy and convenient, and the switch of two modes of transmission requires not any extra component.

The present invention provides a control unit 40 located between the hub 10 and the transmission unit 20, and the hub 10, the transmission unit 20, the ratchet unit 30 and the positioning unit 50 are compatible. All of the components can be modularized so that the manufacturing cost and processes can be reduced. The management for the molds, purchasing material and components is simplified and efficient.

The first and second positioning portions 41, 42 can be integrally formed on the hub 10 and the tubular portion 21 respectively to further simplify the manufacturing processes. The present invention only introduces the control unit 40 to the hub assembly to have obvious economic benefits and convenience for use.

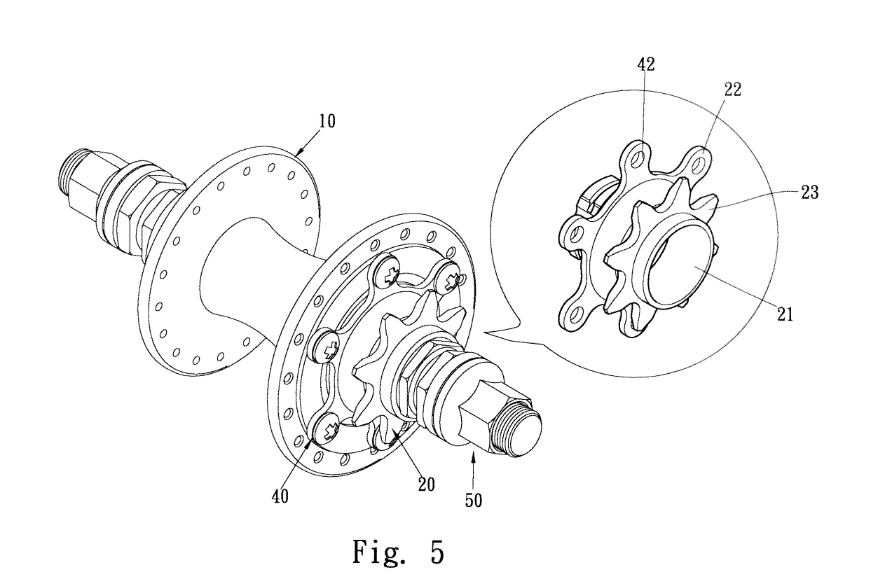

As shown in FIG. 5, the shape of the flange 22 can be modified to include multiple protrusions extending radially therefrom and the each protrusion has one second positioning portion 42. This can reduce the weigh of the flange 22.

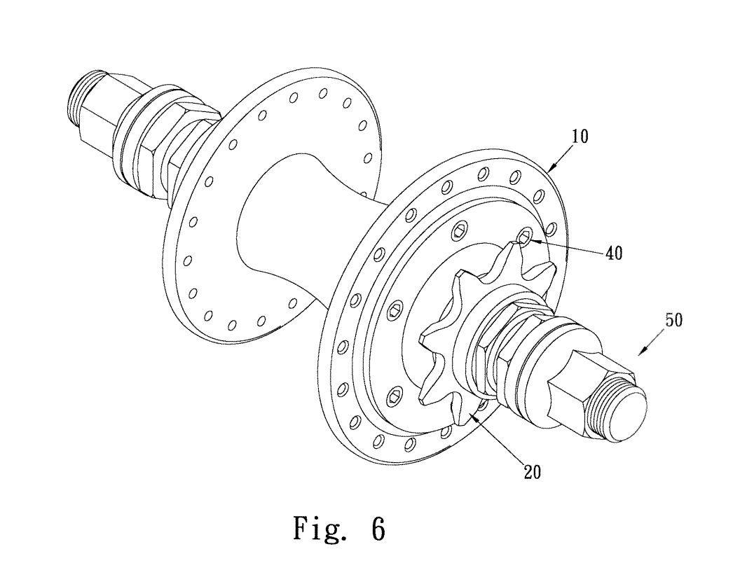

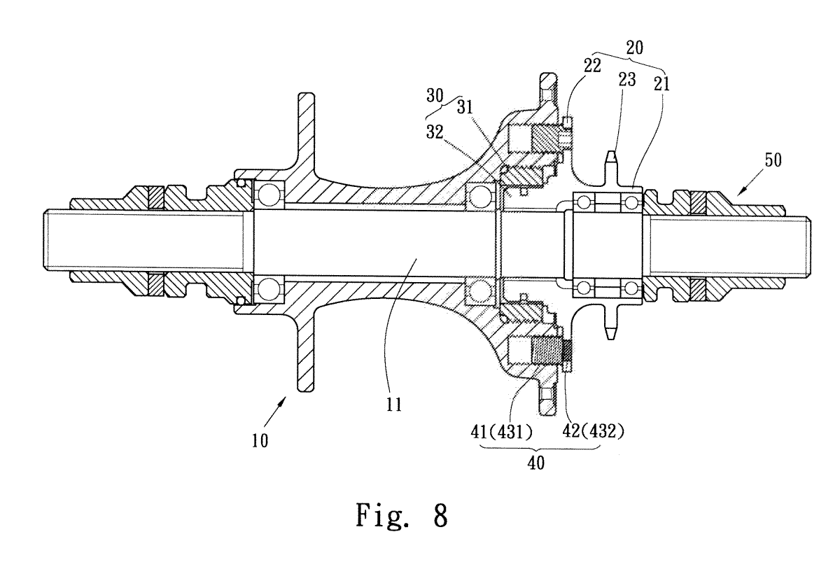

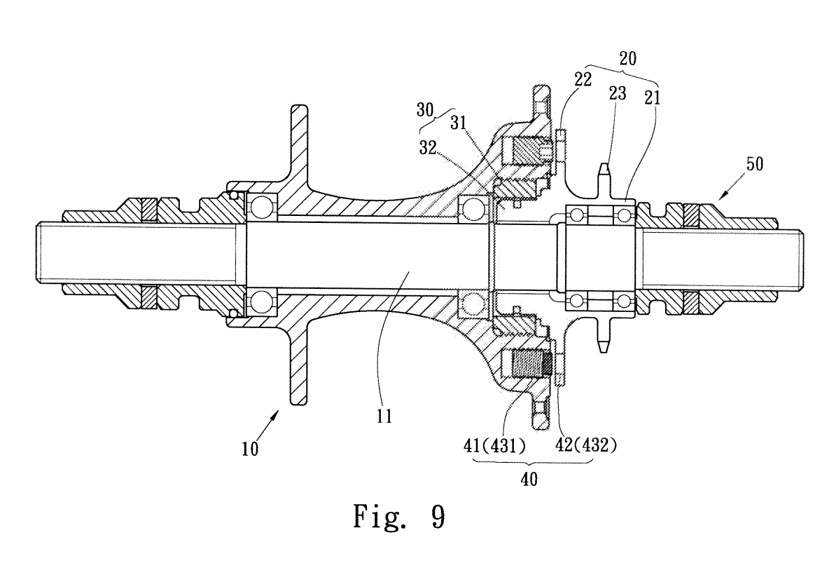

FIGS. 6 to 9 show another embodiment of the present invention, wherein the bolt 43 is a rod-like member and has multiple sections of different diameters and includes a first threaded portion 431 and a second threaded section 432. The first threaded portion 431 is threadedly connected to the first positioning portion 41 and the second threaded portion 432 is threadedly connected to the second positioning portion 42. A hexagonal recess 433 is defined in an end of the second threaded portion 432.

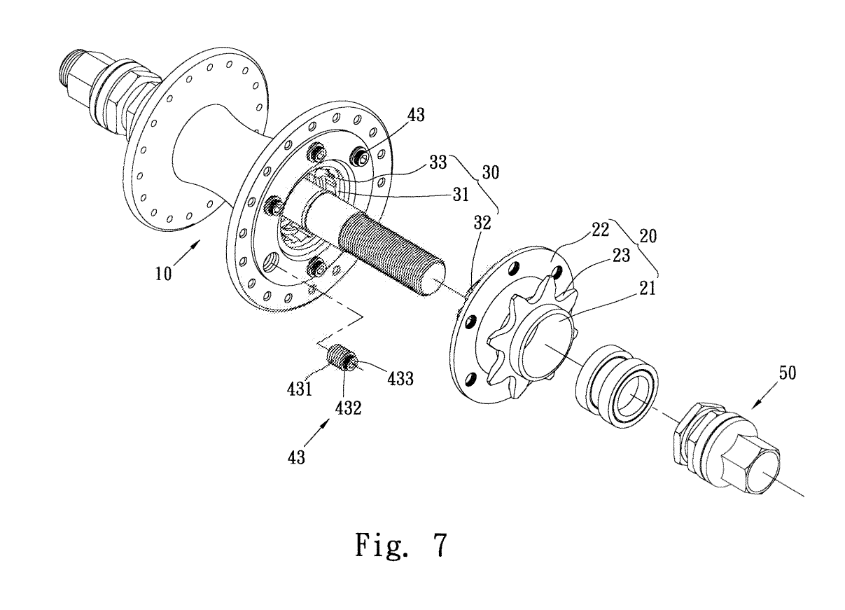

By using a wrench to threadedly connected to the bolts 43 as shown in FIG. 7 in the hexagonal recesses 433, the bolts 43 are rotated toward the second positioning portions 42 to connect the first and second positioning portions 41, 42 together, and the transmission unit 20 is fixed to the hub 10 and directly rotates with the hub 10 in two directions.

When removing the bolts 43 from the hexagonal recesses 433, the bolts 43 are rotated toward the first positioning portions 41 by using the wrench to remove the second threaded portion 432 from the second positioning portion 42, such that the transmission unit 20 is separated from the hub 10. The transferring between the hub 10 and the transmission unit 20 is made by the ratchet unit 30. This is the indirect one-way transmission hub assembly.

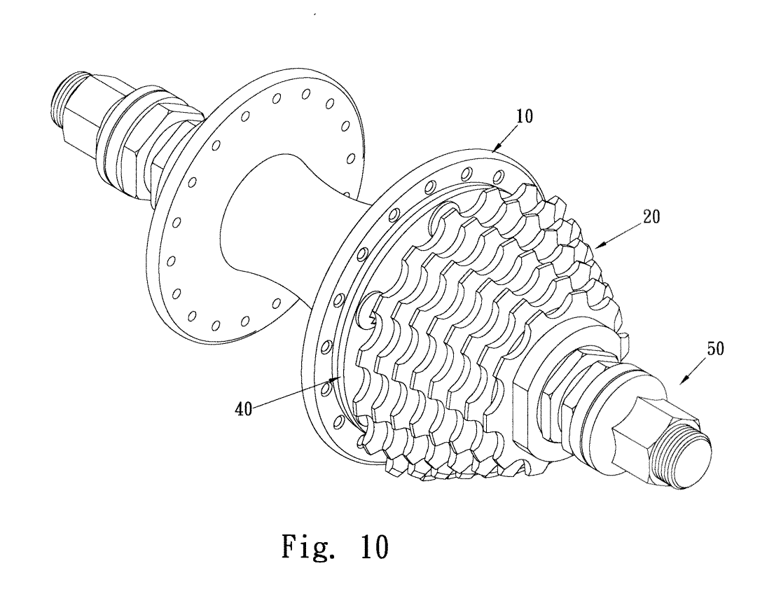

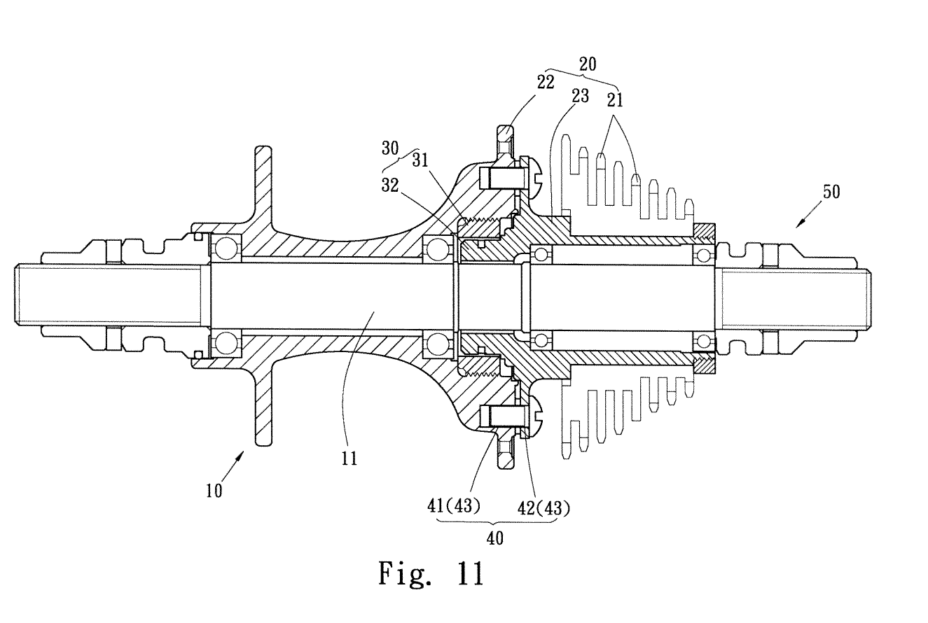

FIGS. 10 and 11 show another embodiment of the present invention wherein a mounting portion 24 is formed on the flange 22 and located opposite to the driving shaft 32. The sprocket 23 includes multiple gears mounted to the mounting portion 24. The multiple gears mounted to the mounting portion 24 provide the function of speed change.

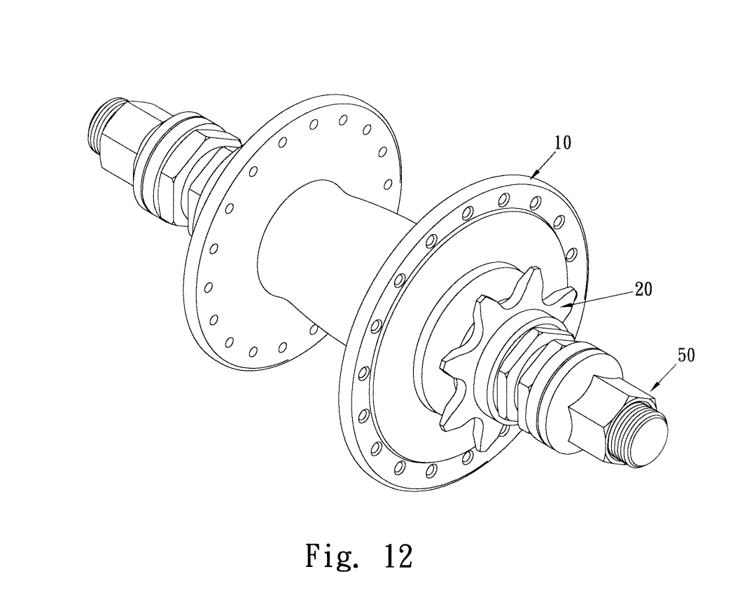

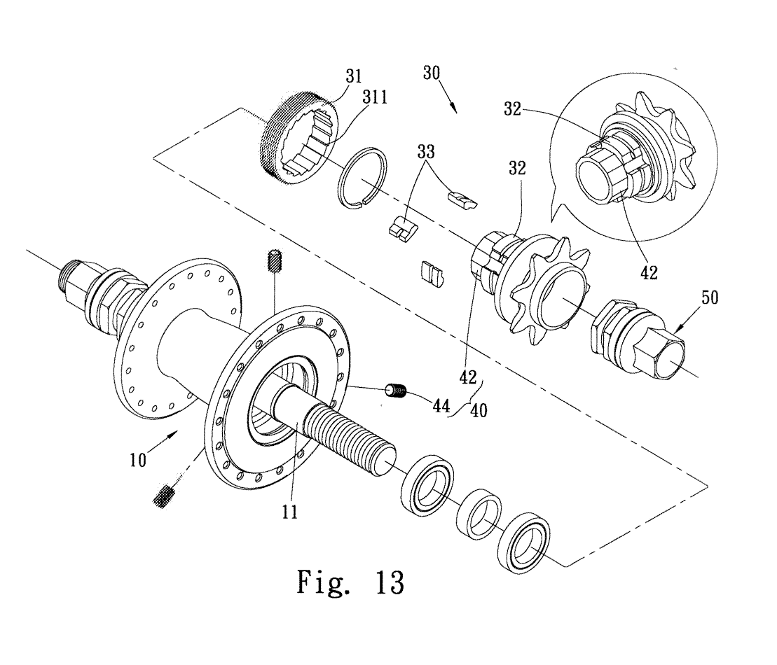

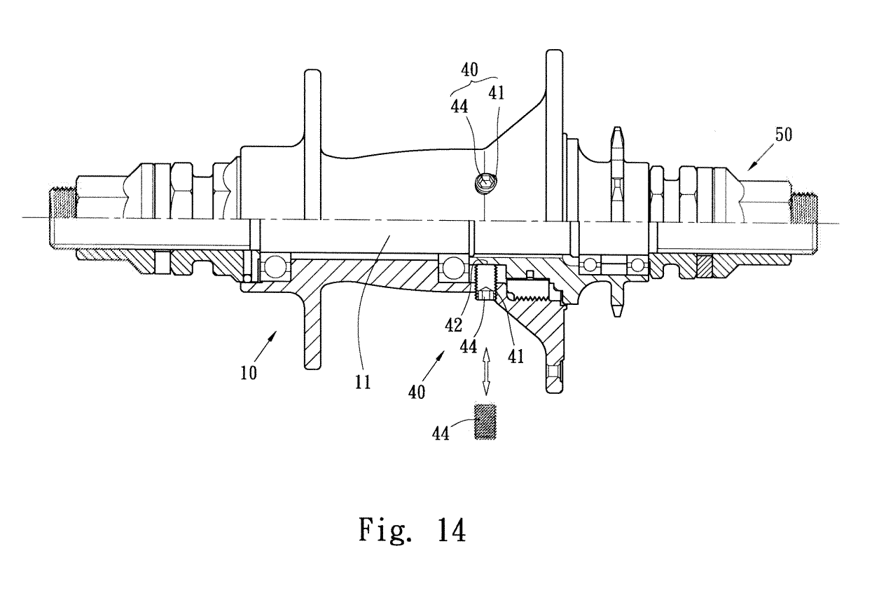

FIGS. 12 to 14 show yet another embodiment and the transmission unit 20 has a tubular portion 21 and a sprocket 23 is connected to the first side of the tubular portion 21. The ratchet unit 30 includes a driving shaft 32 which is integrally formed on the second side of the tubular portion 21. The second positioning portions 42 are integrally formed on stepped surface of the tubular portion 21. The first positioning portions 41 are holes defined through the hub 10 and located corresponding to the second positioning portions 42. Contact members 44 extend through the first positioning portions 41 and contact against outside of the second positioning portions 42.

By the contact members 44 contacting the second positioning portions 42, the first positioning portions 41 and the second positioning portions 42 are operatively connected to each other so as to perform as a direct and two-way transmission hub assembly. On the contrary, when the contact members 44 are removed, the first positioning portions 41 and the second positioning portions 42 are separated from each other, and the hub assembly performs as an indirect and one-way transmission hub assembly.

While we have shown and described the embodiment in accordance with the present invention, it should be clear to those skilled in the art that further embodiments may be made without departing from the scope of the present invention.

What is claimed is:

1. A bicycle hub assembly comprising:
a hub having an axle extending centrally therethrough, the hub being rotatable relative to the axle;
a transmission unit having a tubular portion extending from one end of the hub and at least one sprocket connected to the tubular portion;
a ratchet unit located between the hub and the transmission unit, the hub and the transmission unit being operatively connected to each other indirectly and transferring force in one way by the ratchet unit, and
a control unit having at least one first positioning portion on the hub and at least one second positioning portion integrally formed with the tubular portion, the at least one first positioning portion and the at least one second positioning portion being connected to each other by a bolt, the at least one first positioning portion and the at least one second positioning portion being separated from each other when the bolt is removed.

2. The hub assembly as claimed in claim 1, wherein the tubular portion includes a flange which is larger than the tubular portion and the at least one second positioning portion is located on the flange, the at least one first positioning portion is located at an end of the hub and corresponding to the at least one second positioning portion, the sprocket is connected on a first side of the flange, the ratchet unit includes a driving shaft which is integrally formed on a second side of the flange.

3. The hub assembly as claimed in claim 2, wherein the flange includes multiple protrusions and the at least one second positioning portion is located on one of the protrusions

4. The hub assembly as claimed in claim 1, wherein the bolt has multiple sections of different diameters and includes a first threaded portion and a second threaded section, the first threaded portion is threadedly connected to the at least one first positioning portion and the second threaded portion is threadedly connected to the at least one second positioning portion, a hexagonal recess is defined in an end of the second threaded portion.

5. The hub assembly as claimed in claim 1, wherein the tubular portion includes a flange which is larger than the tubular portion and the at least one second positioning portion is located on the flange, the at least one first positioning portion is located at an end of the hub and corresponding to the at least one second positioning portion, a mounting portion is formed on the flange and the sprocket includes multiple gears mounted to the mounting portion, the ratchet unit includes a driving shaft which is integrally formed on a second side of the flange.

6. The hub assembly as claimed in claim 1, wherein the ratchet unit includes a ratchet ring which is located in an end of the hub, and a driving shaft which is located in opposite to the tubular portion, the ratchet ring includes multiple ratchet teeth in an inner periphery thereof, at least one pawl is pivotably connected to the driving shaft and removably engaged with the ratchet teeth.

7. A bicycle hub assembly comprising:
a hub having an axle extending centrally therethrough, the hub being rotatable relative to the axle;
a transmission unit having a tubular portion extending from one end of the hub and at least one sprocket connected to the tubular portion;
a ratchet unit located between the hub and the transmission unit, the hub and the transmission unit being operatively connected to each other indirectly and in one way by the ratchet unit, and
a control unit having at least one first positioning portion on the hub and at least one second positioning portion integrally formed with the tubular portion, the at least one second positioning portion being integrally formed on stepped surface of the tubular portion, the at least one first positioning portion located corresponding to the at least one second positioning portion, the at least one first positioning portion having at least hole defined in the hub, a contact member extending through the at least one first positioning portion and contacting against outside of the at least one second positioning portion so as to operatively connect the at least one first positioning portion and the at least one second positioning portion, the at least one first positioning portion and the at least one second positioning portion being separated from each other when the contact member is removed.

8. The hub assembly as claimed in claim 1, wherein the sprocket is located on a first side of the tubular portion and a driving shaft is located in opposite to the tubular portion, the driving shaft is integrally formed with the tubular portion and the at least one second positioning portion is integrally formed with a stepped surface of the driving shaft.
